(19) United States
(12) Patent Application Publication
(10) Pub. No.: US 2021/0287556 A1
(43) Pub. Date: Sep. 16, 2021

(54) METHOD AND APPARATUS FOR GENERATING OPTIMAL PATH FOR AN UNMANNED AERIAL VEHICLE

(71) Applicant: ELECTRONICS AND TELECOMMUNICATIONS RESEARCH INSTITUTE, Daejeon (KR)

(72) Inventors: You Kyung HONG, Daejeon (KR); Su Seong KIM, Daejeon (KR)

(21) Appl. No.: 17/200,524

(22) Filed: Mar. 12, 2021

(30) Foreign Application Priority Data
Mar. 13, 2020 (KR) 10-2020-0031573
Mar. 3, 2021 (KR) 10-2021-0027847

(51) Int. Cl. G08G 5/00; B64C 39/02

(52) U.S. Cl. CPC G08G 5/0034; G08G 5/006; B64C 2201/12; B64C 39/024; G08G 5/0069

(57) ABSTRACT

Disclosed are a method and apparatus for generating an optimal path for an unmanned aerial vehicle. The optimal path generating apparatus includes a receiving unit configured to receive a map including surrounding terrain, current state information of the unmanned aerial vehicle, and sensor detection information; and a processor configured to distribute a number of particles on a 3D map having obstacles between a starting point and a goal point set based on the current state information, set initial positions and velocity vectors of the particles, update positions and the velocity vectors of the particles, calculate fitness function values based on the positions and the velocity vectors of the particles, and determine one or more waypoints between the starting point and the goal point and a trajectory connecting the starting point, the one or more waypoints, and the goal point to generate the optimal path.

### CROSS-REFERENCE TO RELATED APPLICATIONS

The present application claims the benefit of priority to Korean Patent Application No. 10-2020-0031573 filed on Mar. 13, 2020 and No. 10-2021-0027847 filed on Mar. 3, 2021 with the Korean Intellectual Property Office (KIPO), the entire contents of which are incorporated herein by reference.

### BACKGROUND

### 1. Technical Field

The present disclosure relates to a path generation technology for an unmanned aerial vehicle and, more particularly, to a method and apparatus for generating an optimal path of the unmanned aerial vehicle to avoid obstacles detected by a sensor in a terrain with obstacles during an autonomous flight of the unmanned aerial vehicle.

### 2. Related Art

An unmanned aerial vehicle (UAV) refers to a drone that can fly without a pilot on board. The unmanned aerial vehicle can fly autonomously or semi-autonomously according to a remote control of the pilot on the ground or according to a pre-programmed path. Recently, the autonomous flight technology of the unmanned aerial vehicle is attracting attention.

FIG. 1 is a block diagram of an apparatus for enabling an autonomous flight of a general unmanned aerial vehicle, and FIG. 2 illustrates an example of a flight path plan for the autonomous flight of the unmanned aerial vehicle.

As shown in FIG. 1, an unmanned aerial vehicle 100 generally includes a path planning module 110, an environment recognition module 120, and a flight control module 130. The unmanned aerial vehicle 100 recognizes its surrounding environment, establishes a flight path, and controls a flight using such modules to perform the autonomous flight.

In particular, when generating the flight path of the unmanned aerial vehicle, the path planning module 110 generally establishes a global path planning, shown in portion (a) of FIG. 2, to determines N-tuple waypoints arbitrarily between a starting point and a goal point and a local path plan, shown in portion (b) of FIG. 2, to connect the N waypoints by a smooth curve. The local path plan is usually established after the establishment of the global path planning.

Though a flight path consisting of straight line segments connecting the N waypoints may be considered to be a shortest path, such a path is not desirable because the path has an infinite curvature at each of the waypoints, and a flight according to such a path may require a motor control command for generating an actuation force larger than a limit of the motor and may cause an overload on the unmanned aerial vehicle.

FIG. 3 illustrates a potential problem that may occur when a smooth curve connecting the N waypoints is generated under a general path plan which designs the global and local path plans separately. In a process of smoothly connecting the N waypoints 40 as shown in portions (a) and (b) of FIG. 3, a new collision may occur with a surrounding obstacle.

In case that a problem may occur as in a case shown in portions (a) and (b) of FIG. 4, a method of adding an auxiliary waypoint 41 between two adjacent waypoints 40 can be contemplated as shown in portion (c) of FIG. 4. FIG. 4 shows an example of adding the auxiliary waypoint 41 between the two adjacent waypoints 40 to derive a desirable result.

In this case, however, the auxiliary waypoint 41 does not always guarantee a safe path. Furthermore, infinite number of auxiliary waypoints may be required occasionally to correct the path for preventing collisions with surrounding obstacles.

As another potential problem, boundary conditions to be satisfied in adjacent segments may be changed due to the addition of the auxiliary waypoint as shown in FIG. 5. In other words, a shape of the path having been generated previously may be changed in adjacent segments, which may result in collision points 20 where the changed path may interfere with surrounding obstacles as shown in FIG. 5.

### SUMMARY

To solve the problems above, provided are a method and apparatus for generating a new flight path for an unmanned aerial vehicle that is safe enough to prevent from a collision with a surrounding obstacle.

Also, provided are a method and apparatus for generating an optimal flight path for an unmanned aerial vehicle that ensures safety without adding any auxiliary waypoint.

Also, provided are a method and apparatus for generating an optimal flight path for an unmanned aerial vehicle based on an integrated path plan taking into account waypoints as well as a smooth path connecting the waypoints.

Additional objects and advantages of the present disclosure can be understood by the following description and will become more apparent by exemplary embodiments of the present disclosure. Also, it will be readily appreciated that the objects and advantages of the present disclosure can be implemented by each means specified in the claims and combinations thereof.

According to an aspect of an exemplary embodiment, a method of generating an optimal path for an unmanned aerial vehicle includes: receiving, through a receiving unit, a map including surrounding terrain information, current state information of the unmanned aerial vehicle, and detection information of a sensor mounted on the unmanned aerial vehicle; populating, by a processor connected to the receiving unit, an arbitrary number of particles on a three-dimensional (3D) map having obstacles between a starting point and a goal point set based on the current state information; setting initial positions and velocity vectors of the particles; updating positions and the velocity vectors of the particles; calculating fitness function values based on the positions and the velocity vectors of the particles; setting the initial positions and the velocity vectors of the particles, updating the positions and the velocity vectors of the particles, and calculating the fitness function values based on the positions and the velocity vectors of the particles to establish an integrated path plan that generates one or more waypoints between the starting point and the goal point with taking into account a trajectory connecting adjacent waypoints; and optimizing the trajectory connecting the starting point, the one or more waypoints, and the goal point using a particle swarm optimization algorithm under the integrated path plan.

According to another aspect of an exemplary embodiment, an apparatus for generating an optimal path for an unmanned aerial vehicle includes: a receiving unit configured to receive a map including surrounding terrain information, current state information of the unmanned aerial vehicle, and detection information of a sensor mounted on the unmanned aerial vehicle; and a processor connected to the receiving unit and configured to distribute a number of particles on a three-dimensional (3D) map having obstacles between a starting point and a goal point set based on the current state information, set initial positions and velocity vectors of the particles, update positions and the velocity vectors of the particles, calculate fitness function values based on the positions and the velocity vectors of the particles, and determine one or more waypoints between the starting point and the goal point and a trajectory connecting the starting point, the one or more waypoints, and the goal point to generate the optimal path.

According to yet another aspect of an exemplary embodiment, an apparatus for generating an optimal path for an unmanned aerial vehicle includes: an acquisition unit configured to receive a map including surrounding terrain information, current state information of the unmanned aerial vehicle, and detection information of a sensor mounted on the unmanned aerial vehicle; a particle distribution processing unit configured to distribute a number of particles on a three-dimensional (3D) map having obstacles between a starting point and a goal point set based on the current state information; a setting unit configured to set initial positions and velocity vectors of the particles; an update unit configured to update positions and the velocity vectors of the particles; a calculation unit configured to calculate fitness function values based on the positions and the velocity vectors of the particles; a generation unit configured to calculate the fitness function values based on the positions and the velocity vectors of the particles, establish an integrated path plan that generates one or more waypoints between the starting point and the goal point with taking into account a trajectory connecting adjacent waypoints, and generate the trajectory connecting the starting point, the one or more waypoints, and the goal point using a particle swarm optimization algorithm under the integrated path plan.

According to an aspect of another exemplary embodiment, an apparatus for generating an optimal path for an unmanned aerial vehicle includes: a receiving unit configured to receive terrain information in a map and current state information of the unmanned aerial vehicle; and a processor configured to generate the optimal path of the unmanned aerial vehicle by establishing an integrated path plan that generates N waypoints and a trajectory connecting the N waypoints by using a particle swarm optimization algorithm.

In an embodiment, the processor may uniformly distribute an arbitrary number of particles in the map by using received terrain information in the map for the particle swarm optimization.

According to an aspect of yet another exemplary embodiment, a method of generating an optimal path for an unmanned aerial vehicle includes: obtaining terrain information in a map; obtaining current state information of the unmanned aerial vehicle, and establishing an integrated path plan to generate the optimal path comprising optimal waypoints. When the integrated path plan is established for a first time, the operation of generating the optimal path includes: distributing an arbitrary number of particles in a 3D map to use a particle swarm optimization algorithm; setting initial positions and velocity vectors of the particles; and calculating fitness function values for the particles. When it is not the first time that the integrated path plan is established, the operation of generating the optimal path includes: updating the positions and the velocity vectors of the particles; and calculating fitness function values for the particles.

According to an aspect of still yet another exemplary embodiment, a program for generating an optimal path for an unmanned aerial vehicle may be stored in a non-transitory computer-readable medium and executable by a computer to cause the computer to: obtain terrain information in a map, obtain current state information of the unmanned aerial vehicle, and establish an integrated path plan to generate the optimal path comprising optimal waypoints and a trajectory. When the integrated path plan is established for a first time, the operation of generating the optimal path includes: distributing an arbitrary number of particles in a 3D map to use a particle swarm optimization algorithm; setting initial positions and velocity vectors of the particles; and calculating fitness function values for the particles. When it is not the first time that the integrated path plan is established, the operation of generating the optimal path includes: updating the positions and the velocity vectors of the particles; and calculating fitness function values for the particles.

According to the present disclosure, the optimal path of the unmanned aerial vehicle may be generated by receiving the terrain information in the map and current state information of the unmanned aerial vehicle, generating N waypoints by a particle swarm optimization algorithm, and generating a trajectory connecting the waypoints.

In addition, the present disclosure enables to generate the optimal path of the unmanned aerial vehicle in consideration of kinematic and dynamic feasibilities of the waypoints and a trajectory connecting adjacent waypoints.

Also, the present disclosure may provide a method and apparatus for generating the optimal path for the unmanned aerial vehicle that does not use auxiliary waypoints.

The present disclosure can enhance the flight safety during the autonomous flight of the unmanned aerial vehicle.

### BRIEF DESCRIPTION OF THE DRAWINGS

FIG. 1 is a block diagram of an apparatus for enabling an autonomous flight of a general unmanned aerial vehicle;

FIG. 2 illustrates an example of a flight path plan for an autonomous flight of a general unmanned aerial vehicle;

FIG. 3 illustrates a potential problem that may occur under a general flight path plan;

FIG. 4 illustrates an example of a conventional method for solving the problem shown in FIG. 3;

FIG. 5 illustrates a potential problem that may occur when the method of FIG. 4 is applied;

FIG. 6 is a conceptual diagram depicting a method of generating an optimal path for an unmanned aerial vehicle according to an embodiment of the present disclosure;

FIG. 7 is a flowchart illustrating a method of generating an optimal path for an unmanned aerial vehicle according to an embodiment of the present disclosure;

FIG. 8 is an illustration of an exemplary optimal path generated by determining all waypoints according to a starting point and a goal point of an unmanned aerial vehicle which may employ the method of FIG. 7;

FIG. 9 is a block diagram of the optimal path generating apparatus of the unmanned aerial vehicle according to another embodiment of the present disclosure;

FIG. 10 illustrates an example of a simulation environment that may be used for the optimal path generating apparatus of the unmanned aerial vehicle shown in FIG. 9;

FIG. 11 illustrates a result of recognizing obstacles by the unmanned aerial vehicle in the environment of FIG. 10;

FIGS. 12A and 12B illustrate simulation results in the environment having obstacles shown in FIGS. 10 and 11;

FIG. 13 show graphs representing time response characteristics of state variables among the simulation results of FIGS. 12A and 12B; and

FIG. 14 illustrates a planned path and an actual trajectory among the simulation results of FIGS. 12A and 12B.

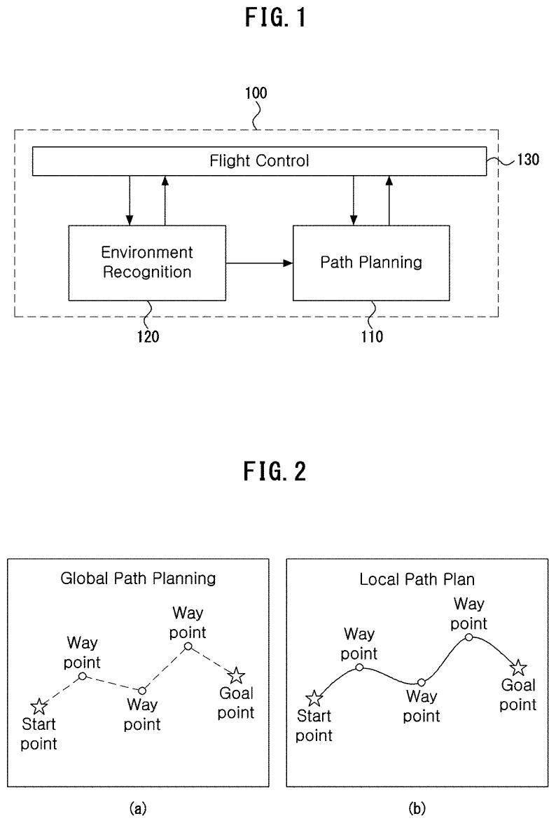

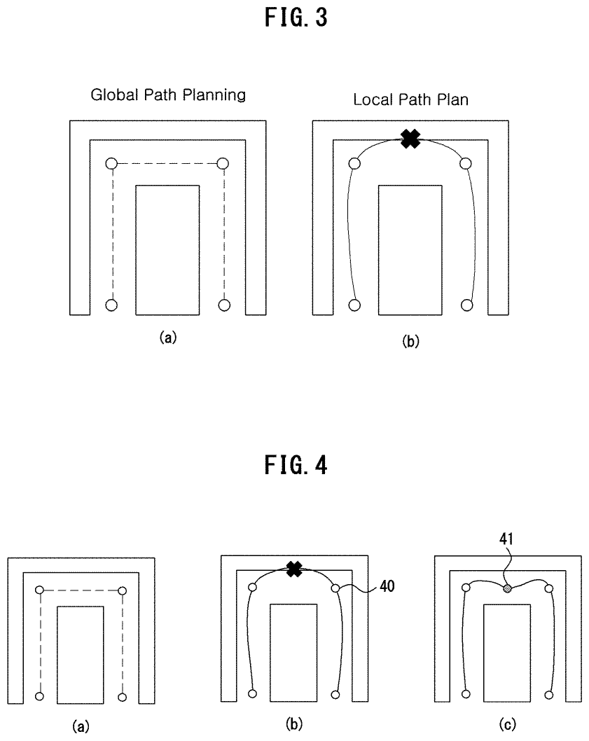

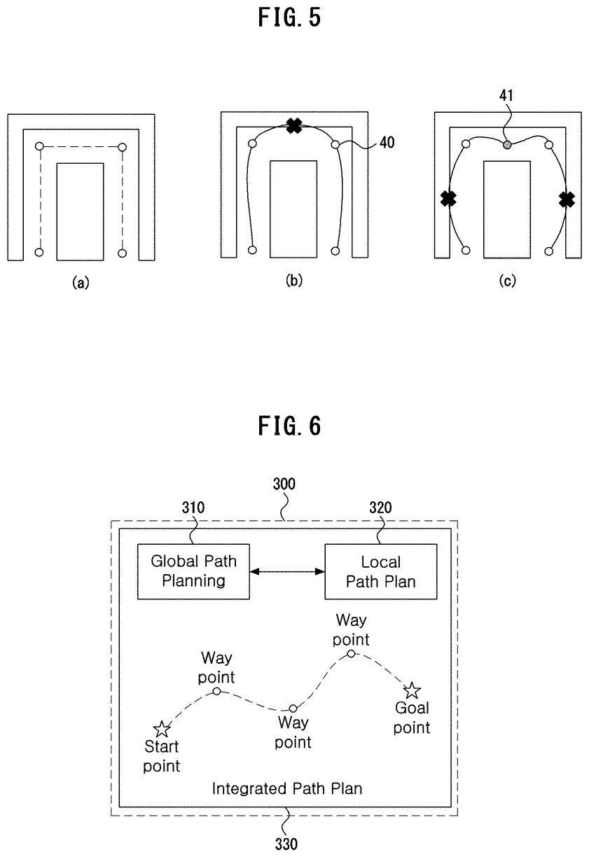

### DETAILED DESCRIPTION

For a more clear understanding of the features and advantages of the present disclosure, exemplary embodiments of the present disclosure will be described in detail with reference to the accompanied drawings. However, it should be understood that the present disclosure is not limited to particular embodiments and includes all modifications, equivalents, and alternatives falling within the idea and scope of the present disclosure.

The terminologies including ordinals such as “first” and “second” designated for explaining various components in this specification are used to discriminate a component from the other ones but are not intended to be limiting to a specific component. For example, a second component may be referred to as a first component and, similarly, a first component may also be referred to as a second component without departing from the scope of the present disclosure. As used herein, the term “and/or” includes any and all combinations of one or more associated items.

When a component is referred to as being “connected” or “coupled” to another component, it means that the component is connected or may be connected logically or physically to the other component. In other words, it is to be understood that the component or may be connected or coupled to the other component indirectly through an object therebetween instead of being directly connected or coupled to the other component.

The terminologies are used herein for the purpose of describing particular embodiments only and are not intended to limit the disclosure. The singular forms include plural referents unless the context clearly dictates otherwise. Also, the expressions “˜ comprises” and “˜ includes” are used to refer a presence of a combination of enumerated features, numbers, processing steps, operations, elements, or components, but are not intended to exclude a possibility of a presence or addition of another feature, number, processing step, operation, element, or component.

Unless defined otherwise, all terms used herein, including technical or scientific terms, have the same meaning as commonly understood by those of ordinary skill in the art to which the present disclosure pertains. Terms such as those defined in a commonly used dictionary should be interpreted as having meanings consistent with meanings in the context of related technologies and should not be interpreted as having ideal or excessively formal meanings unless explicitly defined in the present application.

Hereinafter, embodiments of the present disclosure will be described in more detail with reference to the accompanied drawings. In describing the present disclosure, in order to facilitate an overall understanding thereof, the same components are designated by the same reference numerals in the drawings and are not redundantly described here.

In the present disclosure, a signal reflected from an obstacle or a target outside an unmanned aerial vehicle may be used as a term having a same meaning as a target signal. Also, particles may correspond to a plurality of candidate waypoints on a path through which the unmanned aerial vehicle will travel.

The embodiments of the present disclosure will now be described with reference to the accompanied drawings.

FIG. 6 is a conceptual diagram depicting a method of generating an optimal path for an unmanned aerial vehicle according to an embodiment of the present disclosure.

Referring to FIG. 6, the method of generating an optimal path for an unmanned aerial vehicle, which generates the optimal path in an optimal path generation apparatus 300 implementable by at least a part of a computing device for use in an autonomous flight of the unmanned aerial vehicle, involves an integrated path plan 330 which is a configuration for solving problems inherent to a division into a global path planning 310 and a local path plan 320. Each of the global path planning 310, the local path plan 320, and the integrated path plan 330 may correspond to a first module or a global path planning module having a format of software module, a second module or a local path planning module, and a third module or an integrated path planning module, respectively, or to configuration units which perform respective functions or operations performed by the modules. However, the present disclosure is not limited thereto.

That is, the method of generating the optimal path for the unmanned aerial vehicle according to the present embodiment establishes the integrated path plan 330 generating N waypoints between a starting point and a goal point with taking into account a path connecting adjacent waypoints. Afterwards, the method optimizes the path using a particle swarm optimization to generate optimal waypoints and the optimal path.

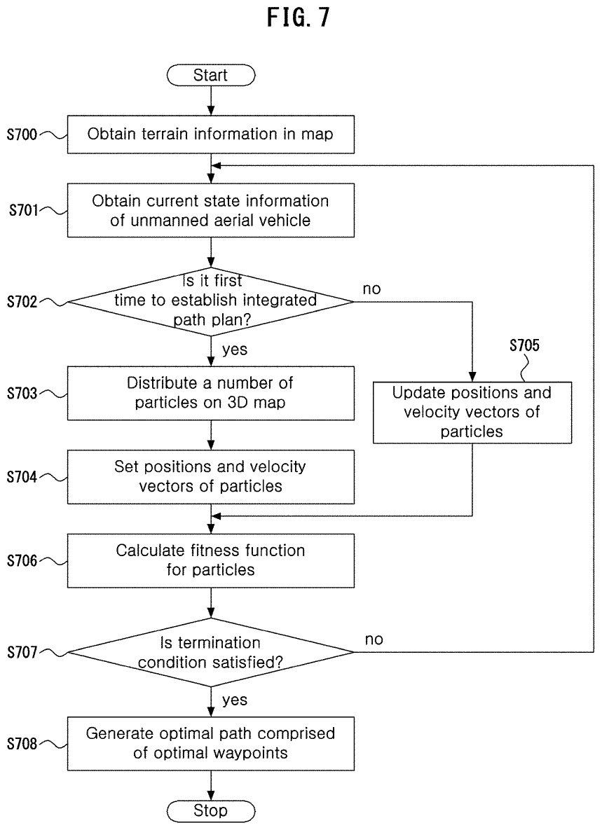

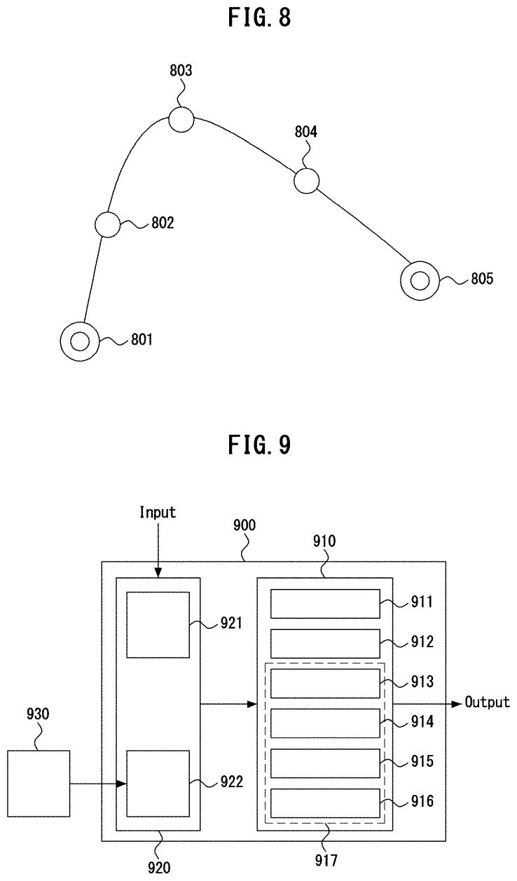

FIG. 7 is a flowchart illustrating the method of generating the optimal path for the unmanned aerial vehicle according to an embodiment of the present disclosure. FIG. 8 is an illustration of an exemplary optimal path generated by determining all waypoints according to the starting point and the goal point of the unmanned aerial vehicle which may employ the method of FIG. 7.

In the present embodiment, the term ‘global path planning’ may refer to a plan for determining the N waypoints that must be passed to move from the starting point to the goal point in consideration of the geometric constraints for the unmanned aerial vehicle to move safely to the desired goal point without colliding with any surrounding obstacle. The term ‘local path plan’ may refer to a plan for connecting the N waypoints by a smooth curve to facilitate a movement of the unmanned aerial vehicle in consideration of the dynamic capabilities of the unmanned aerial vehicle.

Referring to FIG. 7, according to the method of generating an optimal path for an unmanned aerial vehicle, an optimal path generating apparatus including a computing device first obtains terrain information from a map S700 and obtains current state information of the unmanned aerial vehicle S701.

Here, the terrain information in the map may include, for the integrated path plan, the terrain information in a three-dimensional (3D) map of an area where the unmanned aerial vehicle is to fly and may include information on a preset starting point and a goal point.

The terrain information in the 3D map may be received from an external module capable of recognizing an environment or may be acquired by a module in the device capable of recognizing the environment. The terrain information in the 3D map may include information on the terrain in the 3D map and obstacles to be avoided when the path is generated, for example.

The current state information of the unmanned aerial vehicle may be received from an external module controlling the flight or may be acquired by a flight control module in the device, for example. For example, the current state information may include an initial position, a current position, a velocity, an orientation, and an orientational angular velocity of the unmanned aerial vehicle. The orientation information include orientational angles with respect to three axes (i.e., x-axis, y-axis, and z-axis), and the orientational angular velocity may include a rotational angular speed with respect to each axis. Of course, however, the present disclosure is not limited thereto.

Next, it may be determined whether the integrated path plan is established for the first time or not since an operation of the optimal path generating apparatus of the unmanned aerial vehicle S702. In case that it is determined that it is the first time for the optimal path generating apparatus to establish the integrated path plan since its operation (i.e., ‘Yes’ is selected in the operation S702), a number of particles may be distributed on the 3D map where the unmanned aerial vehicle exists or will exist, such that the particles are distributed uniformly on the 3D map, in order to use the particle swarm optimization algorithm in step S703. The uniform distribution of the particles may mean uniformly distributing the particles at locations where the unmanned aerial vehicle can exist using the terrain information in the map.

These particles may be candidate waypoints which may become the waypoints. Since each of the particles is not fixed at its initial position but can be updated continuously, the initial position and velocity of each particle may be set randomly S704.

For example, a current position of each particle may be represented by a current position vector xₛ^{iter} and an initial velocity of each particle may be represented by a velocity vector uₛ^{iter}. And, a previous position or an initial position of each particle may be represented by a previous position vector xₛ^{iter-1} with an index indicating a previous timing. The initial velocity vector may be set to zero vector. That is, the each particle in an initial step may be set to be uniformly distributed in stationary states at respective positions.

The particles distributed uniformly on the 3D map can exchange their position information and objective function values or fitness values with other particles, and can change their positions and velocities continuously based on the fitness values and position information received from the other particles.

In addition, the particles can memorize the positions where they have stayed and can exchange information about such positions with each other. As a result, the particles can share a position associated with an optimal fitness value in a cluster of the particles.

Thus, according to the present embodiment, the particles continuously change their positions and velocities according to the particle swarm optimization algorithm to enable a determination of the position associated with the optimum value on the 3D map. Accordingly, it is possible to find optimal waypoints and generate the optimal path for the unmanned aerial vehicle connecting the waypoints.

Here, in order that the optimal path is generated, a performance index that may be calculated by Equation 2 should be minimized, which will be described below in more detail.

Next, after the initial positions and velocities of the particles are determined, a fitness function value may be calculated for each of all the particles (S706).

A fitness function J may be represented as Equation 1, for example, but it is not limited thereto.

$$J = PI + {\sum }_{k = 1}^{K} {C}_{k} \{ 1 - \prod ( {g}_{k} ) \} \qquad [ Equation 1 ]$$

In the Equation 1, ‘k’ denotes a total number of constraints gₖ, and ‘cₖ’ is a weighting factor which may be set to an arbitrary value sufficiently large, and Π(⋅) is a function that returns a value “0” when the constraint gₖ in the parentheses is satisfied while returning a value “1” when the constraint is not satisfied.

Further, ‘PI’ is the performance index which is desired to be minimized and may be set to the sum of the shortest distances between adjacent two particles as expressed by the Equation 2.

$$PI = ‖ ( {x}_{start} - {w}_{{x}_{1}} , {y}_{start} - {w}_{{y}_{1}} , {z}_{start} - {w}_{{z}_{1}} ) ‖ + {\sum }_{i = 1}^{N - 1} ‖ ( {w}_{{x}_{i + 1}} - {w}_{{x}_{1}} , {w}_{{y}_{i + 1}} - {w}_{{y}_{1}} , {w}_{{z}_{i + 1}} - {w}_{{z}_{1}} ) ‖ + ‖ ( {x}_{goal} - {w}_{{x}_{N}} , {y}_{goal} - {w}_{{y}_{N}} , {z}_{goal} - {w}_{{z}_{N}} ) ‖ \qquad [ Equation 2 ]$$

Here, ‘(xₛₜₐᵣₜ,yₛₜₐᵣₜ,zₛₜₐᵣₜ)’ and ‘(x_{goal},y_{goal},z_{goal})’ may represent the starting point and the goal point, e.g., the starting point 801 and the goal point 805, respectively, shown in FIG. 8.

The constraints mentioned above may mean conditions to be satisfied for generating the optimal path while avoiding surrounding obstacles and generating a dynamically feasible path.

An example of a first kinematic constraint may include that the N waypoints should reside inside the 3D map and be located outside an obstacle. In order that the optimal path is to be generated, a set of the N waypoints should be determined. In the present embodiment, the set of N waypoints may be expressed in a matrix form shown in Equation 3.

$$\begin{matrix}( \begin{matrix}{w}_{{x}_{1}} & {w}_{{y}_{1}} & {w}_{{z}_{1}} \\ ⋮ & ⋮ & ⋮ \\ {w}_{{x}_{N}} & {w}_{{y}_{N}} & {w}_{{z}_{N}}\end{matrix} ) & [ Equation 3 ]\end{matrix}$$

Here, ‘(wₓ_{ᵢ}, w_{y}_{ᵢ}, w_{z}_{ᵢ})’ in first elements of each row of the matrix may represent x-, y-, and z-coordinates of i-th waypoint, and ‘N’ may denote a number of the waypoints excluding the starting point and the goal point.

For example, in FIG. 8 where the starting point 801 and the goal point 805 are illustrated, there are three waypoints, i.e., a first waypoint 802, a second waypoint 803, and a third waypoint 804. In this case, the Equation 3 may have a form of a 3×3 matrix.

Next, a second kinematic constraint may include a condition for the trajectory that the trajectory should smoothly connect two adjacent waypoints among the N waypoints defined in the Equation 3.

For example, a smooth trajectory connecting the starting point 801 and the first waypoint 802, connecting the first waypoint 802 and the second waypoint 803, connecting the second waypoint 803 and the third waypoint 804, and connecting the third waypoint 804 and the goal point 805 may be implemented by a minimum-snap trajectory.

The minimum-snap trajectory should be located inside the 3D map and outside the obstacles as shown by the smooth trajectory connecting the waypoints. To this end, the trajectory may be regarded as a set of discrete points. In other words, a determination of whether the trajectory which is a continuous curve satisfies the kinematic constraints may be replaced by a determination for the set of discrete points.

As a number of the discrete points increases, the difference between the continuous trajectory and the set of the discrete points may decrease. However, the increase in the number of the discrete points may require more time and resources for the determination process for the constraints.

Therefore, through there is no limitation on a time interval between timings corresponding to two adjacent discrete points, it is preferable to generate the discrete points such that the time interval between the timings corresponding to adjacent discrete points is in a range from 0.05 seconds to 0.2 seconds to facilitate the checking of whether or not the constraints are satisfied while consuming moderate time and resources.

For example, assuming that the flight time required to travel from the starting point 801 and the first waypoint 802 is determined to be one second based on the current state information of the unmanned aerial vehicle and the discrete points are generated in the trajectory every 0.1 seconds, nine discrete points may be generated in a corresponding trajectory segment. It is possible to accurately determine whether or not the constraints are satisfied by checking whether the nine discrete points are inside the 3D map and outside the obstacles.

Referring back to FIG. 7, if it is determined in the operation S702 that it is not the first time for the optimal path generating apparatus to establish the integrated path plan (i.e., ‘No’ is selected in the operation S702, the optimal path generating apparatus of the unmanned aerial vehicle may update the positions and the velocity vectors of the particles S705 before calculating the fitness function values for the particles S706.

The updating operation S705 may be repeatedly performed until satisfactory position vectors and velocity vectors of the particles are obtained through a process of determining whether or not a termination condition is satisfied and the process of obtaining the current state information of the unmanned aerial vehicle.

The operation of updating the positions and the velocity vectors of the particles, S705, may be performed according to Equations 4 and 5.

uₛ^{iter}=Kuₛ^{iter}−+c₁r₁(x*ₛ_{ₚ}−xₛ^{iter-1})+c₂r₂(x*_{g}−xₛ^{iter-1}) [Equation 4]

xₛ^{iter}=xₛ^{iter-1}+uₛ^{iter} [Equation 5]

Here, ‘xₛ*ₚ’ denotes a most optimal waypoint, i.e., a best solution, that a particle ‘s’ has experienced. ‘x*_{g}’ may denote a most optimal waypoint that all the particles have experienced, and ‘c₁’ and ‘c₂’ may denote weighting factors that adjust weights of the own experience of the single particle and the experience of other particles. ‘r₁’ and ‘r₂’ may denote uniform random variables having a value in a range between 0 and 1.

Further, ‘K’ denotes an inertia weight and functions an important role in the optimization, that is, in the convergence of the particle swarm optimization algorithm. A large inertia weight may cause the particle ‘s’ to take the past experience more importantly than a new exploration when determining its next position.

Contrarily, a small inertia weight may make the particle ‘s’ to take a new experience obtained through an exploration more importantly than the pat experience when determining its next position. There is no limitation on how to set the inertia weight and, for example, an inertia weight decreasing with time may be applicable. However, a constant inertia weight may be used as well. Also, it may be desirable to determine the inertia weight by appropriately taking into account the experience and the exploration jointly according to circumstances or conditions.

Next, the optimal path generating apparatus of the unmanned aerial vehicle may determine whether the termination condition is satisfied S707. If it is determined that the termination condition is not satisfied, the process returns to the operation S701 and the optimal path generating apparatus may acquire the current state information of the unmanned aerial vehicle that may have been changed.

Meanwhile, if it is determined in the operation S707 that the termination condition is satisfied and new current state information is not required any more, the optimal path generating apparatus may generate an optimal path comprised of optimal waypoints according to an optimization result in step S708.

The optimal path may be the minimum-snap trajectory. When the process of repeatedly updating the position vectors and the velocity vectors of particles is completed, the position vectors of the particles may correspond to the positions of the N waypoints.

Thus, the result of the optimization using the Equation 1 can be expressed by the Equation 3 corresponding to the positions of the N waypoints. In other words, the optimal path generating apparatus may return the set of optimal waypoints corresponding to the most optimal waypoints ‘x*_{g}’ the particles have experienced and generate a final trajectory which may be the minimum-snap trajectory connecting the optimal waypoints smoothly. The minimum-snap trajectory generated as above can be the optimal path for the unmanned aerial vehicle.

The termination condition may be determined to be satisfied when a standard deviation of the fitness values calculated for the last 20 times is within a preset tolerance range, for example.

According to the present embodiment, the optimal path for the unmanned aerial vehicle may be generated by establishing the integrated path plan taking into account a smooth trajectory to be generated in advance when determining the N waypoints.

FIG. 9 is a block diagram of the optimal path generating apparatus of the unmanned aerial vehicle according to another embodiment of the present disclosure.

Referring to FIG. 9, the optimal path generating apparatus 900 of the unmanned aerial vehicle (hereinbelow, referred to as “optimal path generating apparatus”) may be installed in the unmanned aerial vehicle. However, the optimal path generating apparatus 900 may be used in a state being separated from the unmanned aerial vehicle as well. The optimal path generating apparatus 900 may include a receiving unit 920 receiving the terrain information in the 3D map and the current state information of the unmanned aerial vehicle and a processor 910 establishing the integrated path plan by generating the N waypoints and the trajectory connecting the waypoints by the particle swarm optimization algorithm to generate the optimal path for the unmanned aerial vehicle.

The receiving unit 920 may receive or input the terrain information in the 3D map and the current state information of the unmanned aerial vehicle from outside. Here, the terrain information in the 3D map may include information on the terrain in the 3D map and obstacles to be avoided when the path is generated. The current state information may include an initial position, a current position, a velocity, an orientation, and an orientational angular velocity of the unmanned aerial vehicle. The receiving unit 920 may provide the received information to the processor 910.

The receiving unit 920 may receive a map including the surrounding terrain information, the current state information of the unmanned aerial vehicle, and detection information of a sensor mounted on the unmanned aerial vehicle. To this end, the receiving unit 920 may be connected to a module located inside or outside the unmanned aerial vehicle and recognizing the surrounding or an external environment of the unmanned aerial vehicle, a module controlling the flight of the unmanned aerial vehicle, or a sensor 930 through an internal communication interface, a short-range wireless communications network, a mobile communications network, a satellite communications network, or a combination thereof. The sensor may include an object detection sensor, a distance detection sensor, a posture detection sensor, a speed detection sensor, and the like.

More specifically, the receiving unit 920 may include a communication module 921 and an input stage 922. The communication module 921 may support a plurality of communication protocols. The communication protocol is a system of formats and rules that allows computers and communication devices spaced apart to transmit and receive signals and data and may include a signaling system, an authentication function, and an error detection and correction function. The receiver 920 may support the communications through the short-range wireless communications, the mobile communications, the satellite communications, or a combination thereof. The input stage 922 may include means for converting an input analog signal or a digital signal into a digital signal that can be processed by the processor 910 or a configuration corresponding to such means. The configuration may include an analog-to-digital converter, a digital-to-digital converter, a filter, an amplifier, or a combination thereof.

The processor 910 may be an entity generating the optimal path by using the particle swarm optimization algorithm. The processor 910 may populate an arbitrary number of particles on the 3D map where the unmanned aerial vehicle exists or will exist such that the particles are distributed uniformly on the 3D map to use for the particle swarm optimization algorithm by executing the modules 911-917 loaded therein. The processor 910 may set the position vectors and the velocity vectors of the particles and may perform a process of repeatedly updating the position vectors and the velocity vectors of the particles while calculating the fitness for the particles. In addition, the processor 910 may generate the minimum-snap trajectory using the returned optimal waypoints set when the termination condition is satisfied and output the minimum-snap trajectory as the optimal path for the unmanned aerial vehicle.

To this end, the processor 910 may include a first acquisition unit 911 acquiring the terrain topographic information in the map, a second acquisition unit 912 acquiring the current state information of the unmanned aerial vehicle, and a generation unit 917 establishing the integrated path plan and generating the optimal path comprised of the optimal waypoints.

In addition, the processor 910 may include a particle distribution processing unit 913, a setting unit 914, and a calculation unit 915, all of which may be provided in the generation unit 917 which generates the optimal path. The particle distribution processing unit 913 may distribute an arbitrary number of particles on the 3D map to use the particle swarm optimization algorithm when the integrated path plan is established for the first time. The setting unit 914 may set the initial position vectors and the velocity vectors of the particles. The calculation unit 915 may calculate the fitness function for the particles.

The processor 910 may further include an updater 916 that updates the positions and the velocity vectors of the particles when it is not the first time that the integrated path plan is established. An output stage of the updater 916 may be connected to an input stage of the calculation unit 915 calculating the fitness function values for the particles.

The first acquisition unit 911, the second acquisition unit 912, the particle distribution processing unit 913, the setting unit 914, the calculation unit 915, the updater 916, or a combination thereof may be implemented by one or more software modules mounted on the processor 910. Also, the first acquisition unit 911, the second acquisition unit 912, the particle distribution processing unit 913, the setting unit 914, the calculation unit 915, the updater 916, or a combination thereof may be implemented to be stored in a recording medium and loaded onto the processor 910 in response to a task triggering event for generating the optimal path to perform respective functions.

In the optimal path generating apparatus, the acquisition units 911 and 912 may receive the maps including the surrounding terrain information, the current state information of the unmanned aerial vehicle, and the detection information of the sensor mounted on the unmanned aerial vehicle. The particle distribution processing unit 913 may populate an arbitrary number of particles, on the 3D map including the obstacle, between the starting point and the goal point set based on the current state information. The setting unit 914 may set the initial position vectors and the velocity vectors of the particles. The updater 915 may update the position vectors and the velocity vectors of the particles. The calculation unit 916 may calculate the fitness function value based on the position vectors and the velocity vectors of the particles. The generation unit 917 may establish the integrated path plan that generates one or more waypoints between the starting point and the goal point with taking the trajectory connecting the adjacent waypoints into account, and may generate the trajectory connecting the starting point, the one or more waypoints, and the goal point under the integrated path plan by the particle swarm optimization algorithm.

In particular, the calculation unit may calculate the sum of the weights when the constraints including the kinematic conditions are satisfied and the sum of the performance index to be minimized in the unmanned aerial vehicle. Here, the performance index may be calculated by the sum of the shortest distances between adjacent particles. The constraints may be conditions for generating the optimal path while avoiding the surrounding obstacles and generating a dynamically feasible path.

The constraints may include a first condition, which is a kinematic condition, that a plurality of waypoints are positioned inside the 3D map boundary but outside the obstacles—where, the first condition may be expressed by an N×N matrix when the number of the waypoints is N—and a second condition, which is a trajectory condition, that any two adjacent waypoints among the N waypoints are to be connected by a minimum-snap trajectory.

The generation unit may generate the optimal waypoints based on the positions having the optimal values and may determine the trajectory connecting the optimal waypoints as the optimal path of the unmanned aerial vehicle.

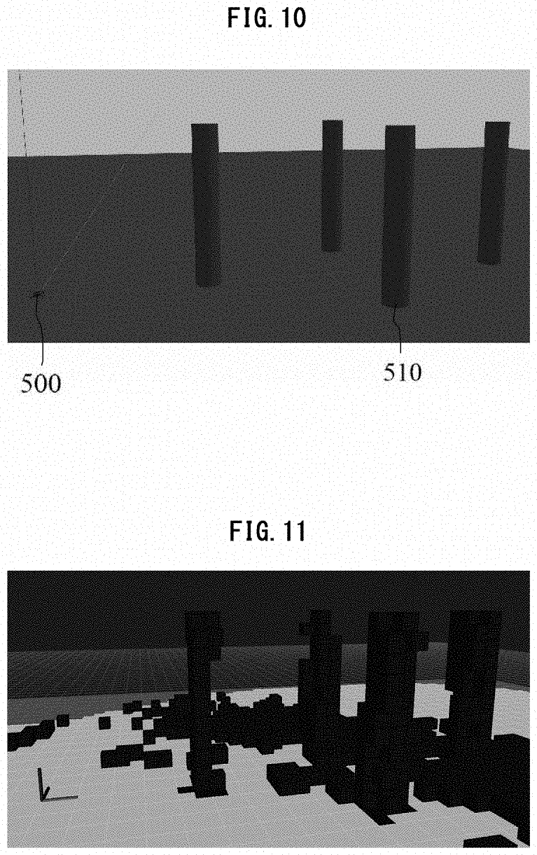

FIG. 10 illustrates an example of a simulation environment that may be used for the optimal path generating apparatus of the unmanned aerial vehicle shown in FIG. 9. FIG. 11 illustrates a result of recognizing obstacles by the unmanned aerial vehicle in the environment of FIG. 10.

A simulation according to the present embodiment was performed in a Gazebo simulator, which is a virtual physical simulator based on a robot operating system (ROS), for the task of generating the optimal path of the unmanned aerial vehicle.

A shape of the terrain with protruding obstacles 510 existing in the 3D map is shown in FIGS. 10 and 11 assuming that there exist four cylinder-shaped obstacles 510 with a length of 5 meter (m) and a radius of 0.4 m in a space of 25 m×10 m×3 m of the map. In the present embodiment, the shape of the terrain in which the obstacles 510 are located should be taken into account when the optimal path for the unmanned aerial vehicle 500 is generated.

In other words, an environment recognition module, the unmanned aerial vehicle model which is a virtual control object, and a control system may be required to evaluate a complete path generation method of the unmanned aerial vehicle 500 in addition to the path plan generated by a flight path generation system including the optimal path generating apparatus according to the present embodiment.

Accordingly, in the present embodiment, a 3D occupancy grid map representing the obstacles in the map was generated using OctoMap libraries and used as the environment recognition module. The 3D occupancy grid map was generated at a grid spacing of one meter, and a Hokuyo laser range finder was used as a sensor to detect the obstacles. The maximum range of the sensor was set to ten meters. An output of the sensor may represent a probability value ranging from 0 to 1 indicating whether there exists an obstacle at an arbitrary point in the space. The 3D occupancy grid map was generated in advance by determining that there exists an obstacle at a point in the space when the probability value for the point is greater than 0.5.

A 3DR iris quadcopter model including even a first order drag effect in the kinematic equation was used as the unmanned aerial vehicle model.

The control system was implemented based on PX4 firmware v190 which is an open source. Referring back to FIGS. 10 and 11, the coordinates of the starting point and the goal point may be set to (0 m, 0 m, 15 m) and (19 m, −1 m, 25 m), respectively. In such a case, the optimal path generating apparatus may determine that three waypoints are required between the starting point and the goal point in consideration of the distance between the starting point and the goal point and the shape of the terrain with the obstacles 510. Thus, the optimal path generating apparatus may determine the positions of the three waypoints by performing the optimal path generation method described above with reference to FIG. 7.

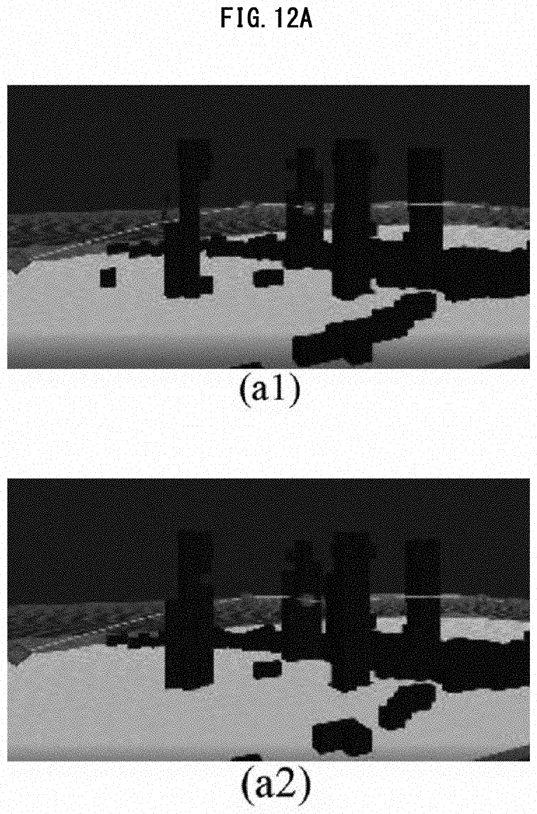

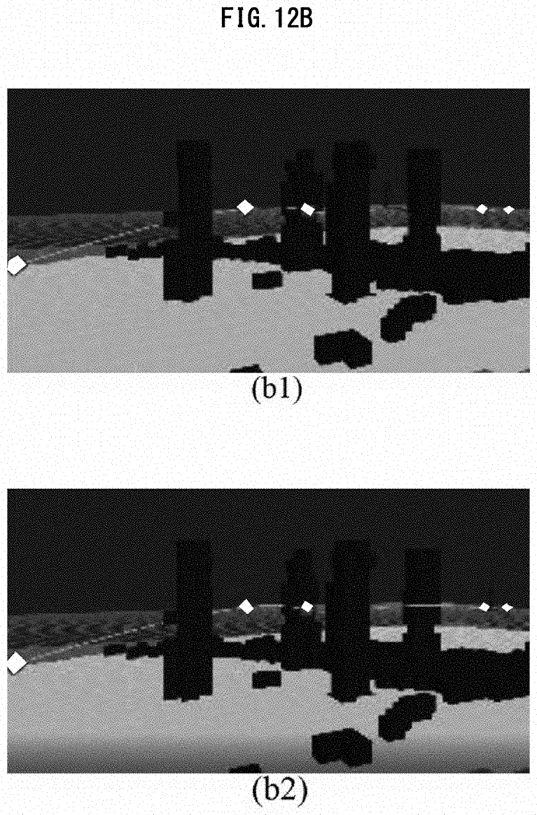

FIGS. 12A and 12B illustrate simulation results in the environment having the obstacles shown in FIGS. 10 and 11.

The simulation results shown in a1, a2, b1, and b2 of FIGS. 12A and 12B are snapshots taken every 2 seconds during the simulation. The square shaped points indicates the positions of the starting point, the goal point, and the waypoints between them, and the solid line or the dotted line connecting the starting point, the waypoints, and the goal point is a spline or a smooth curve passing near two adjacent waypoints. The positions of the three waypoints are determined by the optimal path generation method according to the present embodiment. It can be seen that both the square shaped points of the waypoints and the line between them are located inside the map boundary and outside the obstacles due to the kinematic constraints taken into account in the present embodiment.

In the present embodiment, the number of iterations until the particle swarm optimization converges was fifty two, and the calculation time elapsed in a notebook computer equipped with a 260 GHz Intel i7 CPU processor was 0.42 seconds. The coordinates of the three waypoints determined as a result of the optimization were (707 m, 132 m, 294 m), (936 m, 042 m, 281 m), and (1748 m, −113 m, 269 m), respectively.

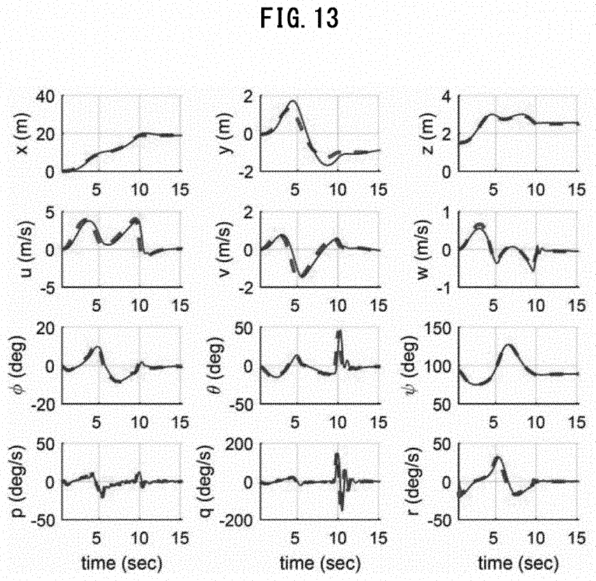

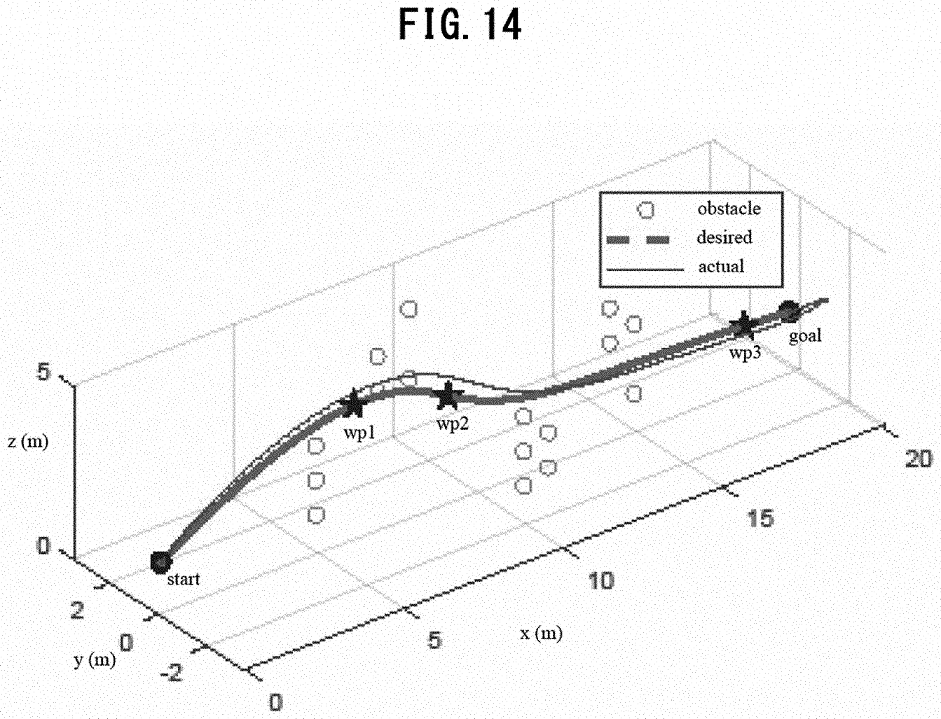

FIG. 13 show graphs representing time response characteristics of state variables among the simulation results of FIGS. 12A and 12B. FIG. 14 illustrates a planned path and an actual trajectory among the simulation results of FIGS. 12A and 12B.

FIG. 13 shows temporal variations of the states of the unmanned aerial vehicle including the position, the velocity, the orientation expressed by Euler angles, and the orientational angular velocity of the unmanned aerial vehicle during the simulation process according to the optimal path generation method of the present embodiment.

In FIG. 13, a thick dotted line indicates the desired path generated by the integrated path planning according to the present embodiment, while a thin solid line indicates the actual trajectory of the unmanned aerial vehicle.

That is, as shown in FIG. 14, the unmanned aerial vehicle can fly the desired path and the actual trajectory in the three-dimensional space with avoiding the obstacles detected using its own sensor.

As described above, according to the optimal path generating apparatus and method in the unmanned aerial vehicle according to the present embodiment, the unmanned aerial vehicle can generate the trajectory suitable for flight while avoiding the collision with the obstacles on the 3D map and fly along the trajectory.

Various embodiments of the present disclosure are not intended to show all possible combinations, but are intended to describe representative aspects of the present disclosure. The features described with regard to the various embodiments may be applied independently, but may be applied in combination of two or more of associated features also.

Various embodiments of the present disclosure may be implemented by hardware, firmware, software, or a combination thereof. In case of the hardware implementation, the embodiments may be implemented by one or more application-specific integrated circuits (ASICs), digital signal processors (DSPs), digital signal processing devices (DSPDs), programmable logic devices (PLDs), field programmable gate arrays (FPGAs), general purpose processors, controllers, microcontrollers, or microprocessors. Also, the various embodiments may be implemented in a form of a program stored in a non-transitory computer readable medium that can be used in a terminal or an edge or a program stored in a non-transitory computer readable medium that can be used in a cloud or an edge. For example, an embodiment of the present disclosure, as a shape of a program for generating the optimal path for the unmanned aerial vehicle, may be implemented in a combination of a single or multiple software components and a single or multiple hardware components.

The scope of the present disclosure includes software or machine-executable instructions such as an operating system, an application program and firmware which enables the operations according to the methods of various embodiments to be executed on a device or computer, and a non-transitory computer-readable medium which stores such a software or instructions to be executed on the device or computer.

While exemplary embodiments have been described with reference to the drawings, it will be understood by those of ordinary skill in the art that various changes and modifications can be made without departing from the spirit and scope defined by the following claims.

What is claimed is:

1. A method of generating an optimal path for an unmanned aerial vehicle, comprising:
receiving, through a receiving unit, a map including surrounding terrain information, current state information of the unmanned aerial vehicle, and detection information of a sensor mounted on the unmanned aerial vehicle;
distributing, by a processor connected to the receiving unit, a number of particles on a three-dimensional (3D) map having obstacles between a starting point and a goal point set based on the current state information;
setting initial positions and velocity vectors of the particles;
updating positions and the velocity vectors of the particles;
calculating fitness function values based on the positions and the velocity vectors of the particles;
establishing an integrated path plan that generates one or more waypoints between the starting point and the goal point and takes into account a trajectory connecting adjacent waypoints through the setting the initial positions and the velocity vectors of the particles, the updating the positions and the velocity vectors of the particles, and the calculating the fitness function values based on the positions and the velocity vectors of the particles; and
optimizing the trajectory connecting the starting point, the one or more waypoints, and the goal point using a particle swarm optimization algorithm under the integrated path plan.

2. The method of claim 1, wherein the integrated path planning comprises:
a global path planning for determining at least one waypoint in consideration of geometric constraints only to move the unmanned aerial vehicle avoiding surrounding obstacles from the starting point to the goal point; and
a local path plan for connecting the at least one waypoint determined through the wide-area route plan by a smooth curve in consideration of dynamic characteristics of the unmanned aerial vehicle.

3. The method of claim 1, wherein the terrain information is obtained from a module located outside the unmanned aerial vehicle recognizing a surrounding environment or a module mounted on the unmanned aerial vehicle and recognizing the surrounding environment, and includes information on the terrain in the 3D map and information on the starting point and the goal point set in the 3D map,
wherein the information on the terrain in the 3D map comprises information on obstacles to be avoided during a path generation.

4. The method of claim 1, wherein the current state information is obtained from an external module controlling a flight of the unmanned aerial vehicle from outside the unmanned aerial vehicle or an internal module mounted on the unmanned aerial vehicle and controlling the flight of the unmanned aerial vehicle, and comprises an initial position, a current position, a velocity, an orientation, and an orientational angular velocity of the unmanned aerial vehicle, wherein the orientation comprises orientational angles with respect to three axes, and the orientational angular velocity comprises rotational angular speeds.

5. The method of claim 1, wherein the distributing of the particles is executed such that the particles are uniformly distributed at locations where the unmanned aerial vehicle can exist in the 3D map, the particles being candidates for the one or more waypoints.

6. The method of claim 1, wherein the setting of the initial positions and the velocity vectors of the particles comprises:
setting the initial positions of the particles to arbitrary positions where respective particles are located at stationary states; and setting initial velocity vectors of the particles to zero vector,
wherein each of the particles distributed uniformly on the 3D exchanges position information and the fitness function values with other particles on a program related to the integrated path plan executed on a computing device, changes its position and velocity continuously based on the position information and the fitness values, and memorize the position,
wherein the particles exchange information of positions where they have stayed with each other.

7. The method of claim 6, wherein the particle swarm optimization algorithm makes the particles to determine positions having optimal values on the 3D map while changing respective positions and velocities,
wherein the calculating of the fitness function comprises calculating a total sum of a sum of weights when constraints including kinematic conditions are satisfied and a sum of a performance index to be minimized in the unmanned aerial vehicle,
wherein the performance index is calculated by a sum of shortest distances between adjacent particles,
wherein the constraints are conditions for generating the optimal path while avoiding the surrounding obstacles and generating a dynamically feasible path.

8. The method of claim 7, wherein the constraints comprise:
a first condition being a kinematic condition that a plurality of waypoints are positioned inside the 3D map boundary but outside the obstacles, the first condition being expressed by an N×N matrix when a number of the waypoints is N; and
a second condition being a trajectory condition that any two adjacent waypoints among the N waypoints are connected by a minimum-snap trajectory.

9. The method of claim 1, wherein the particle swarm optimization algorithm makes the particles to determine positions having optimal values on the 3D map while changing respective positions and velocities,
wherein the optimizing of the trajectory comprises generating optimal waypoints and a trajectory connecting the optimal waypoints as the optimal path of the unmanned aerial vehicle based on the positions of the particles having the optimal values.

10. The method of claim 1, wherein the updating of the positions and the velocity vectors comprises: updating the velocity vector of each particle to a current velocity vector by adding a first value obtained by applying a first weight for adjusting a weight of an experience of the corresponding particle to a first optimal waypoint corresponding to a best position experienced by the corresponding particle, a second value obtained by applying a second weight for adjusting a weight of an experience of other particles to a second optimal waypoint corresponding to a best position experienced by the particle cluster, and a third value obtained by applying an inertia weight to the velocity vector of the corresponding particle to take into account a convergence of the corresponding particle to the particle cluster; and
updating the position of the corresponding particle to a current position according to a previous position and the current velocity vector of the corresponding particle.

11. The method of claim 10, wherein the inertia weight includes a first inertia weight and a second inertia weight smaller than the first inertia weight,
wherein the first inertial weight is a relatively high inertia weight and has a tendancy that each particle takes a past experience more importantly than a new exploration when determining a next position,
wherein the second inertial weight is a relatively small inertia weight and has a tendency that each particle takes the new exploration more importantly than the past experience when determining the next position.

12. The method of claim 1, further comprising: returning or outputting an optimal waypoints set for the particle cluster and generating a final trajectory smoothly connecting the waypoints in the optimal waypoints set by producing a minimum-snap trajectory, by the processor, when a termination condition is satisfied after the optimizing operation.

13. An apparatus for generating an optimal path for an unmanned aerial vehicle, comprising:
a receiving unit configured to receive a map including surrounding terrain information, current state information of the unmanned aerial vehicle, and detection information of a sensor mounted on the unmanned aerial vehicle; and
a processor connected to the receiving unit and configured to populate an arbitrary number of particles on a three-dimensional (3D) map having obstacles between a starting point and a goal point set based on the current state information, set initial positions and velocity vectors of the particles, update positions and the velocity vectors of the particles, calculate fitness function values based on the positions and the velocity vectors of the particles, and determine one or more waypoints between the starting point and the goal point and a trajectory connecting the starting point, the one or more waypoints, and the goal point to generate the optimal path.

14. The apparatus as claimed in claim 13, wherein the processor, when the setting of the initial positions and the velocity vectors of the particles, sets the initial positions of the particles to arbitrary positions where respective particles are located at stationary states and sets the velocity vectors of the particles to zero vector,
wherein each of the particles distributed uniformly on the 3D exchanges position information and the fitness function values with other particles on a program related to the integrated path plan executed on a computing device, changes its position and velocity continuously based on the position information and the fitness values, and memorize the position,
wherein the particles exchange information of positions where they have stayed with each other.

15. The apparatus as claimed in claim 13, wherein the particle swarm optimization algorithm executed by the processor makes the particles to determine positions having optimal values on the 3D map while changing respective positions and velocities,
wherein a calculation unit mounted in the processor calculates a total sum of a sum of weights when constraints including kinematic conditions are satisfied and a sum of the weights and a performance index to be minimized in the unmanned aerial vehicle,
wherein the performance index is calculated by a sum of shortest distances between adjacent particles, and
wherein the constraints are conditions for generating the optimal path while avoiding the surrounding obstacles and generating a dynamically feasible path.

16. The apparatus as claimed in claim 15, wherein the constraints comprise:
a first condition being a kinematic condition that a plurality of waypoints are positioned inside the 3D map boundary but outside the obstacles, the first condition being expressed by an N×N matrix when a number of the waypoints is N, the N being a natural number; and
a second condition being a trajectory condition that any two adjacent waypoints among the N waypoints are connected by a minimum-snap trajectory.

17. An apparatus for generating an optimal path for an unmanned aerial vehicle, comprising:
an acquisition unit configured to receive a map including surrounding terrain information, current state information of the unmanned aerial vehicle, and detection information of a sensor mounted on the unmanned aerial vehicle;
a particle distribution processing unit configured to distribute a number of particles on a three-dimensional (3D) map having obstacles between a starting point and a goal point set based on the current state information;
a setting unit configured to set initial positions and velocity vectors of the particles;
an update unit configured to update positions and the velocity vectors of the particles;
a calculation unit configured to calculate fitness function values based on the positions and the velocity vectors of the particles;
a generation unit configured to establish an integrated path plan that generates one or more waypoints between the starting point and the goal point with taking into account a trajectory connecting adjacent waypoints based on the calculating the fitness function values based on the positions and the velocity vectors of the particles, and generate the trajectory connecting the starting point, the one or more waypoints, and the goal point using a particle swarm optimization algorithm under the integrated path plan.

18. The apparatus as claimed in claim 17, wherein the particle swarm optimization algorithm makes the particles to determine positions having optimal values on the 3D map while changing respective positions and velocities,
wherein the calculations unit calculates a total sum of a sum of weights when constraints including kinematic conditions are satisfied and a sum of the weights and a performance index to be minimized in the unmanned aerial vehicle,
wherein the performance index is calculated by a sum of shortest distances between adjacent particles,
wherein the constraints are conditions for generating the optimal path while avoiding the surrounding obstacles and generating a dynamically feasible path.

19. The apparatus as claimed in claim 18, wherein the constraints comprise:
a first condition being a kinematic condition that a plurality of waypoints are positioned inside the 3D map boundary but outside the obstacles, the first condition being expressed by an N×N matrix when a number of the waypoints is N, the N being a natural number; and
a second condition being a trajectory condition that any two adjacent waypoints among the N waypoints are connected by a minimum-snap trajectory.

20. The apparatus as claimed in claim 17, wherein the particle swarm optimization algorithm makes the particles to determine positions having optimal values on the 3D map while changing respective positions and velocities,
wherein the generation unit generates optimal waypoints based on the positions having the optimal values and determines a trajectory connecting the optimal waypoints as the optimal path of the unmanned aerial vehicle.
